(19) United States
(12) Patent Application Publication
(10) Pub. No.: US 2012/0016546 A1
(43) Pub. Date: Jan. 19, 2012

(54) System and Method for Supplying Back-Up Electric Power to a House from a Hybrid Vehicle

(76) Inventors: Ole K. Nilssen, Barrington, IL (US); James P. Phillips, Lake in the Hills, IL (US); Sharon E.J. Phillips, Lake in the Hills, IL (US)

(21) Appl. No.: 13/181,657

(22) Filed: Jul. 13, 2011

Related U.S. Application Data
(60) Provisional application No. 61/364,152, filed on Jul. 14, 2010.

(51) Int. Cl. B60W 20/00; B60W 10/08; B60W 10/06

(52) U.S. Cl. 701/22; 180/65.265; 903/902

(57) ABSTRACT

A system and method for supplying back-up electric power to a house or other building from a hybrid vehicle. Switches in the vehicle and in the house can place the vehicle in a mode where it receives charging power from the house, or where it can supply power into the main electrical distribution system of the house. These switches can be controlled from a control module in the house that can sense or cause the vehicle to sense if there is adequate ventilation in the environment to start the internal combustion engine (ICE) in the vehicle. The control module or the vehicle can cause a garage door to open or ventilation fans or vents to open. If the ICE can be started, the generator/battery can supply most if not all of the power needed by the house until the outage is over. If there is inadequate ventilation, the control system can cause only the battery in the vehicle to supply limited power to the house, typically only to critical circuits. When main power is restored, the system can revert back automatically. The ICE can be turned off anytime there is inadequate ventilation or an abnormal condition.

This application is related to and claims priority from U.S. Provisional Patent Application No. 61/364,152 filed Jul. 14, 2010. Application 61/364,152 is hereby incorporated by reference.

### BACKGROUND

1. Field of the Invention

The present invention relates generally to back-up electrical power and more particularly to the safe use of a hybrid electric vehicle to provide back-up power to a residence or small business.

2. Description of the Problem

Hybrid electric vehicles containing both an electric motor and an internal combustion engine are becoming popular because of their increased fuel economy. The Toyota Prius and Ford Fusion are examples of this type of vehicle. Many other hybrids are expected to be on the market soon.

Modern homes have become extremely dependent on the almost uninterrupted supply of electrical power to run refrigerators, freezers, furnaces, air conditioning, sump pumps and lighting. While a typical home can tolerate a short power outage, an extended outage can cause major problems. Every year extended power outages are reported in various locations due to weather and other causes such as ice storms, high winds, tornados, hurricanes and even traffic accidents and power distribution equipment failures. To combat this danger, some home owners have invested in emergency generators; however, maintenance and upkeep of these specialty devices (that are typically not used often) many times is neglected. The result is that the emergency generator may not be available when required. It would be very desirable to be able to supply emergency power from a device that is well maintained to assure its availability.

The family automobile is such a device that is used often and usually maintained, at least to the point where it will operate. The problem with the use of a standard automobile (non-electric or hybrid) to supply emergency power to a house or small business is that a typical automobile's alternator does not have enough capacity to supply the amount of power typically required. Regardless of any power conversion equipment that might be added to the alternator of a typical car or truck, the necessary capacity is simply not present.

A hybrid vehicle on the other hand has a generator that has considerable power capability. This generator is normally used to charge the vehicle's batteries in order to run the electric motor(s). A hybrid vehicle also has a much larger battery storage capacity than a single typical car battery. Thus, a hybrid vehicle, without modification, contains the basic power plant that could be used in an emergency to power a house, namely a generator with sufficient power output, an internal combustion engine to turn that generator, and a battery to also hold charge and supply power. It would be advantageous to be able to use a hybrid vehicle to supply power to a home or small business for an extended period of time during an electrical outage.

### SUMMARY OF THE INVENTION

The present invention relates to using a hybrid vehicle to power a home or small business (or other building) in a safe manner. The battery of a hybrid vehicle is capable of supplying back-up power to a household for a limited time for a portion of the critical requirements, while the generator is usually capable of supplying all the power needed for an extended period of time because generators in hybrid vehicles are designed for a large power output in almost continuous operation.

The output of the hybrid vehicle's power system is normally a relatively high DC voltage (usually several hundred volts). This DC voltage must be inverted and supplied at the correct AC frequency and voltage to be connected to the main electric distribution box of the building. In the US, this can be 60 Hz at either 220-240 volts or 110-120 volts. During short outages, the vehicle's battery can be used alone without starting the internal combustion engine. For longer outages, it will be necessary to start the internal combustion engine. The present invention mitigates the dangerous effects of the vehicle's exhaust gases in the latter case.

### DESCRIPTION OF THE FIGURES

Attention is now directed to several figures that illustrate features of the present invention:

FIG. 1 shows the connection of a hybrid vehicle to the main electric distribution box of a home.

FIG. 2 is a block diagram of the connection of FIG. 1.

FIG. 3 is a flow chart of a control algorithm.

Several drawings and illustrations have been presented to aid in understanding the present invention. The scope of the present invention is not limited to what is shown in the figures.

### DESCRIPTION OF THE INVENTION

The present invention relates to using a hybrid vehicle as an emergency power back-up for a home or small business. Most plug-in or non-plug-in hybrid vehicles incorporate a battery and a generator to supply power to the vehicle's electric motor. The battery usually has enough capacity to supply critical power needs to a home for a limited time. The generator/battery combination with the internal combustion engine running usually has enough capacity to supply the total electrical requirements of a home for an extended time. Running the internal combustion engine (ICE) in a garage of course presents several practical and safety concerns, the most important of which is the production of carbon monoxide. Thus, for extended outages, where it is necessary to run the internal combustion engine, ventilation is mandatory.

It is very desirable for the battery and generator of the hybrid vehicle to have automatic operation in a power failure if the vehicle is of the type that can be plugged into house power. A typical house main is supplied at 220-240 volts that is usually split into two 110-120 volt halves at the main electric distribution box. Some circuits such as clothes dryers and air conditioners are operated across the outside of this split at 220 volts. The rest of the circuits are operated at 110-120 volts through groups of either 15 amp or 20 amp circuit breakers. If a single 15 or 20 amp 110 volt circuit is plugged into the vehicle, then the vehicle can, at most, supply only that much current into that one side of the main. The vehicle, in that case, would only be able to supply half the circuits in the house, and then with a maximum that equals the value of the breaker. On the other hand, if the vehicle charging supply (or a special portal for the vehicle's power supply to drive is supplied) is rated at the full 220-240 volts with a fairly large amperage capacity, and wired directly into the house's main electric distribution box, the vehicle can supply both halves of the split and also drive any 220 volt devices if necessary.

A control system can be provided that upon power failure, first provides battery power, and then causes the ICE to start putting the vehicle's generator online. This control system can automatically make sure that adequate ventilation is provided by either 1) causing the garage door to open, or 2) causing ventilator fans to turn on and/or 3) ventilation slots to open. This is ideally done by battery power before the ICE is started. In addition, optional carbon monoxide sensors can monitor the space to make sure CO is not reaching dangerous levels, and if so, shut off the ICE. The ideal situation, as stated, is for the control system (which includes an inverter) to be directly tied into a 220 volt main feed point for the house.

Many newer vehicles have built-in garage door remote controls that can be programmed or trained to operate the owner's garage door. Some garage door openers also have battery power to be able to operate during a power outage; however, the majority of garage door openers do not have this feature. It is thus generally important for the vehicle battery to have enough capacity to open the garage door without having to start the ICE (so the garage door is fully open before the ICE is started). The control unit (which can be run on a small backup battery) can sense the need to open the garage door; switch in the vehicle's battery to critical circuits (at least to the garage door circuit), and open the garage door.

Some newer vehicles have sensors that detect blockage when the vehicle is backing. These sensors could be used to detect blockage of the rear of the vehicle due to a closed garage door. The vehicle could then supply the necessary power from its battery to open the door as it activates the vehicles internal garage door opener transmitter. If the sensor then detects that the garage door is open, the ICE could start if necessary. Alternatively, a simple optical sensor can be used on the garage door to inform the control unit if the door is open or closed.

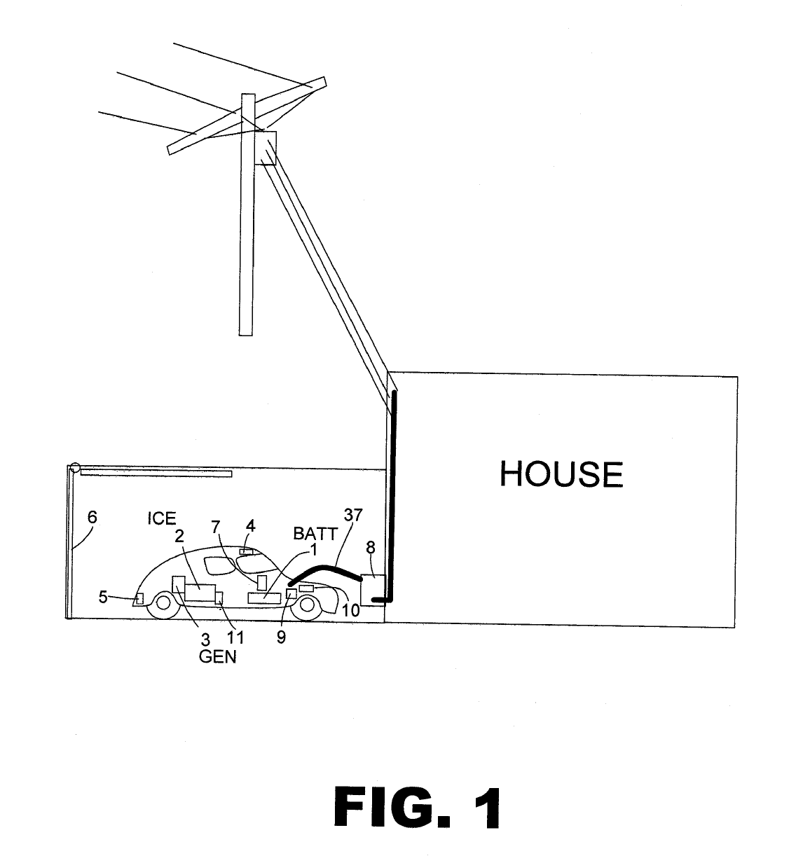

As shown in FIG. 1, the present invention incorporates devices readily available on hybrid electric vehicles with a few additional devices in the vehicle and in the household to provide back-up electrical power. The vehicle contains a storage battery 1 for supplying instantaneous power and for starting the ICE 2. It also contains a generator 3, a garage door opener remote control or transmitter unit 4 that may be programmable and optional backing sensors 5 that can detect that a garage door 6 is closed or open. The following devices may be added to the vehicle, or in some cases, may be located in a control unit in the garage near the vehicle: an electrical power inverter 7 capable of operating from the battery and/or the generator, a power cable 37 for connecting the vehicle to the house's main electric distribution box 8, encoders and decoders 9 for communication between the household and the vehicle, switching capability 10 to reconfigure the vehicle from a recipient of electrical power to a power source, and access 11 to various vehicle sensors to determine the vehicle's capability to safely deliver power to the house. The following sensors should be monitored: 1) engine temperature, 2) generator temperature, 3) inverter temperature, 4) battery temperature, 5) battery charge level, 6) fuel level, 7) carbon monoxide level in the environment near the vehicle. Finally, capability to activate the switchover from the AC mains to the hybrid vehicle and capability to supply high power AC or DC out of the vehicle must be added to the vehicle.

In the house, the following modifications or devices are recommended: 1) segregation of branch circuits into three classes, namely a) devices needed to qualify the vehicle's environment for ICE operation such as the garage door opener and optional intake or outlet ventilation fans or vents, b) devices with high priority for electric power such as refrigerators, freezers, furnaces, sump pumps and emergency lighting, and c) other devices with low priority such as normal lighting, entertainment, computers and comfort cooling, 2) encoders and decoders for data communication with the vehicle, and 3) control logic capable of implementing a control algorithm.

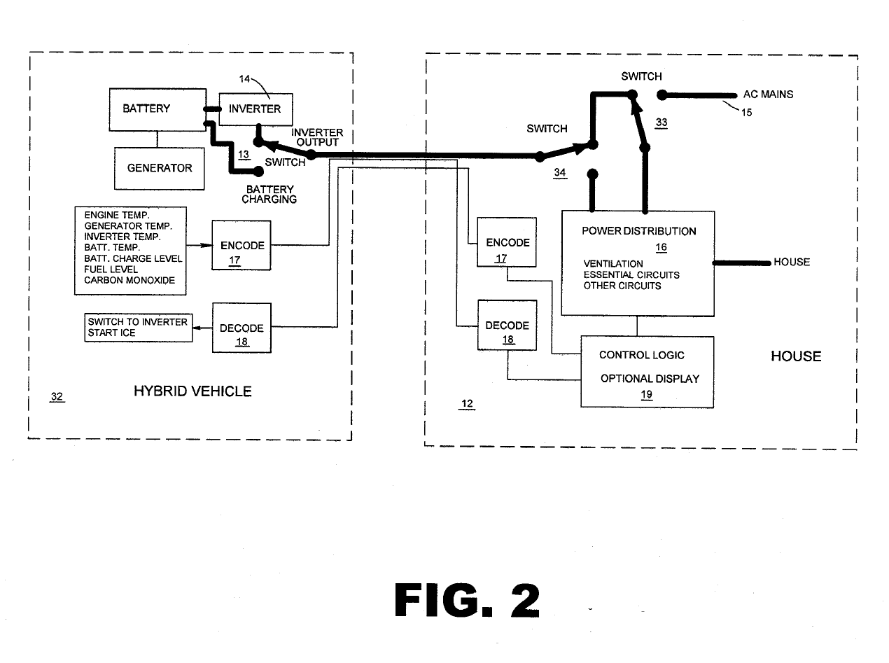

FIG. 2 shows a block diagram of a hybrid vehicle 32 and a household 12. The vehicle 32 contains a switch 13 that chooses between the vehicle receiving AC charging power from the house, or the house receiving AC power from the inverter 14 in the vehicle. The house 12 also contains a switch 34 that switches between a direct connection to the vehicle for charging or the vehicle connected into the AC mains 15. In FIG. 2, a power distribution module 16 is shown between the switch 34 and the mains 15. This power distribution module 16 can contain control of ventilation circuits, the garage door and essential house circuits. Data can also flow bidirectionally between the vehicle 34 and the house 12. Each end of the data circuit can contain an encoder 17 and decoder 18. Data can be multiplexed on the power wiring between the vehicle and the house, or optionally, it can be carried over separate wires or cables. A control unit 19 on the house side can sense a power failure and send a message to the vehicle to supply battery power. With this battery power, the control unit can control ventilation, apply vehicle power to sensitive circuits or all circuits, and signal the vehicle to start the ICE. The control unit 19 can also contain an optional carbon monoxide sensor.

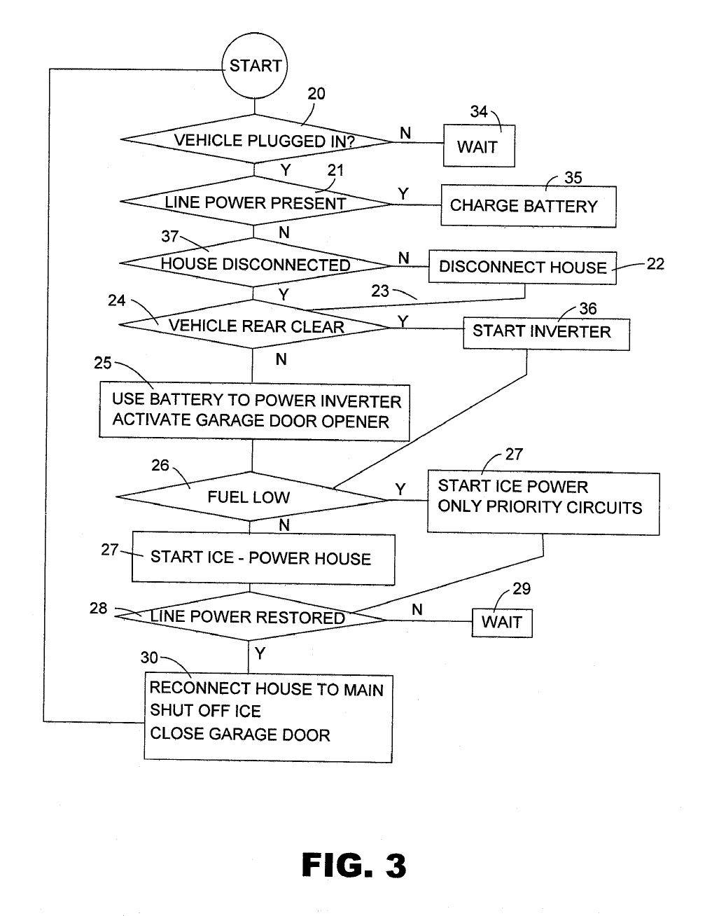

FIG. 3 shows a flow chart of a possible control algorithm. The algorithm first 20 determines if the vehicle and the household are connected with an adequate cable to supply power to the household. If connected, the algorithm determines 21 if power is being (or can be) supplied by the household. If household power is present, the vehicle's battery will be charged. If there is a power failure, the household is first disconnected 22 from the AC mains. After verification 23 that the disconnect is complete, the algorithm can check 24 for clearance behind the vehicle (or otherwise determine if the garage door is open). If the door is closed, the algorithm can activate 25 the garage door using power from the vehicle's battery to open it. The door can be triggered directly from the garage door remote transmitter in the vehicle or directly from the control unit. When the rear of the vehicle is clear, or it is otherwise determined 26 that the garage door is open (or alternatively that there is adequate ventilation), a command can be issued to start 27 the vehicle's ICE 2 FIG. 1. Once the ICE and generator are running, the household can be switched 28 to vehicle power. The vehicle battery can be simultaneously charged. Optionally, the control circuit can connect the low priority household circuits or all the household circuits depending on the fuel level of the vehicle. The vehicle generator can continue to operate as long as there is a proper environment to run (proper ventilation and safe CO levels), there is fuel available, and the power from the AC mains remains unavailable. When power from the AC mains is restored to the house, the house can be disconnected 29 from the vehicle's power, the ICE can be stopped 30, and the entire house reconnected 31 to the AC mains. The system then returns to the standby state recharging the vehicle battery from the house mains if necessary.

As previously stated, a carbon monoxide sensor can be advantageously installed on the vehicle. An optimum place for this sensor can be on the air intake to the ICE since here there will be maximum airflow past the sensor. A second carbon monoxide sensor can also be located in the control unit or elsewhere in the garage. ICE shutdown should be immediate when an unsafe CO condition is sensed along with an optional alarm. A safety override system that is independent of all other systems can optionally be installed that forces the vehicle ICE to stop when too high a level of CO is sensed. Also, the ICE should always be shut down, and the house disconnected, whenever any unsafe temperature or condition is sensed.

In situations where the garage does not open to the outdoors, other special arrangements can be made such as additional ventilation fans and the like. Also, numerous other connect/disconnect scenarios and algorithms are possible and are within the scope of the invention. For example, in some installations, segregation of household circuits may not be possible or economical. In this case, if the system determines that enough power is available from the vehicle, the entire household load can be switched onto the vehicle at one time. In other cases, it may be determined that only emergency or high priority circuits will be switched to the vehicle. In still other cases, staged switching of various circuits can be made either automatically or manually. Also, during vehicle charging when main power is on, a fuse or circuit breaker should normally be placed in the AC charging circuit; however, if main power is off, and the vehicle will supply power to the household, this fuse or breaker may need to be bypassed ether totally, or with a fuse or breaker of higher rating. Finally, the power cable between the vehicle and the household needs to be of adequate size and rating to carry the maximum load current that will be supplied to the house. This may be a larger cable than is normally required for normal charging.

Several descriptions and illustrations have been presented to aid in understanding the features of the present invention. One skilled in the art will realize that numerous changes and variations are possible without departing from the spirit of the invention. Each of these changes and variations is within the scope of the present invention.

We claim:

1. A method of providing back-up electrical power to house comprising:
attaching said vehicle to said house so that the vehicle can supply electrical power into the main electrical distribution box of said house when commercially supplied power is unavailable;
automatically monitoring said vehicle to assure adequate ventilation to start and run an internal combustion engine in said vehicle;
automatically starting said internal combustion engine when said ventilation is adequate;
automatically supplying electrical power to said house while said commercially supplied power is unavailable;
automatically ceasing to supply electrical power to said house when said commercially supplied power is restored;
automatically shutting off said internal combustion engine when said becomes inadequate.

2. The method of claim 1 wherein a power cable is connected between said vehicle and said house.

3. The method of claim 1 further comprising charging a battery in said vehicle when said commercial power is available.

4. The method of claim 1 wherein a data cable is connected between said vehicle and said house.

5. The method of claim 1 wherein power and data are multiplexed on a single cable between said vehicle and said house.

6. An system for connecting a hybrid vehicle to a house to supply back-up AC power in case of a power failure comprising:
a inverter capable of converting DC from said vehicle to proper voltage and frequency to power said house;
a switch in said vehicle adapted to receive power from said house in a first mode charging a battery, and adapted to supply power to said house in a second mode;
a switch in said house adapted to supply power to said vehicle in a first mode and adapted to receive power from said vehicle in a second mode;
a control unit in said house sensing presence of commercial electric power causing said switch in the vehicle and said switch in the house to change modes when commercial electric power is unavailable;
wherein, said control unit also continually senses for adequate ventilation to cause an internal combustion engine in said vehicle to start and run;
and wherein, said control unit stops said internal combustion engine when commercial power is restored and causes said switch in the vehicle and said switch in the house to return to a normal mode.

7. The apparatus of claim 6 wherein a sensor notifies said control unit if a garage door is open or shut.

8. The apparatus of claim 6 wherein said control unit can cause a garage door to open or close.

9. The apparatus of claim 6 wherein main power in said house is segregated into high priority, essential and low priority, non-essential circuits.

10. The apparatus of claim 6 wherein said vehicle supplies limited electric power to said house from a battery alone.
